(19) United States
(12) Patent Application Publication
(10) Pub. No.: US 2026/0220429 A1
(43) Pub. Date: Jul. 30, 2026

(54) REDUCED-BANDWIDTH DISTRIBUTED TRAINING OF LARGE NEURAL NETWORKS

(71) Applicant: GDM Holding LLC, Mountain View, CA (US)

(72) Inventors: Arthur Douillard, London (GB); Yanislav Donchev, London (GB); Arthur David Szlam, New York, NY (US); Marc'Aurelio Ranzato, London (GB); Paul Ronald Barham, San Francisco, CA (US)

(21) Appl. No.: 19/436,128

(22) Filed: Dec. 30, 2025

Related U.S. Application Data
(60) Provisional application No. 63/751,082, filed on Jan. 29, 2025.

(51) Int. Cl. G06N 3/045; G06N 3/08

(52) U.S. Cl. CPC G06N 3/045; G06N 3/08

(57) ABSTRACT

Techniques for using a distributed computing system to train a neural network to perform a machine learning task. The techniques enable efficient training whilst reducing the bandwidth required between worker computer systems of the distributed computing system. In some aspects the neural network is split into fragments to reduce peak communication bandwidth during the training. These can be referred to as streaming implementations. In some aspects the system is arranged to reduce latency and idle time cause by relatively low bandwidth connections between worker computer systems, in particular to mitigate worker computer system waiting time or “blocking”. These can be referred to as eager update implementations. Streaming and eager updates can be combined. The techniques are particularly useful for training very large neural networks, and when the worker computer systems are not co-located.

### CROSS-REFERENCE TO RELATED APPLICATION

This application claims priority under 35 U.S.C. 119 to Provisional Application No. 63/751,082, filed Jan. 29, 2025, which is incorporated by reference.

### BACKGROUND

This specification relates to training neural networks.

Neural networks are machine learning models that employ one or more layers of nonlinear units to predict an output for a received input. The neural networks described herein include one or more hidden layers in addition to an output layer. The output of each hidden layer is used as input to the next layer in the network, i.e., the next hidden layer or the output layer. Each layer of the network generates an output from a received input in accordance with current values of a respective set of trainable parameters, e.g. weights.

### SUMMARY

This specification generally describes systems and methods implemented as computer programs on one or more computers for using a distributed computing system to train a neural network to perform a machine learning task. The described techniques enable efficient training whilst reducing the bandwidth required between worker computer systems of the distributed computing system. The techniques are particularly useful for training large neural networks, e.g. with greater than 109 trainable parameters, and facilitate the use of worker computer systems that are not co-located with one another.

In some aspects the neural network is split into fragments to reduce peak communication bandwidth during the training. These can be referred to as streaming implementations.

In some aspects the system is arranged to reduce latency and idle time caused by relatively low bandwidth connections between worker computer systems, in particular to mitigate worker computer system waiting time or “blocking”. These can be referred to as eager update implementations. Optionally, features of streaming and eager update implementations can be combined.

In one aspect there is described a method of training a neural network using a distributed computing system, in particular for streaming implementations. The distributed computing system comprises a plurality of worker computer systems, and the neural network comprising a plurality of learnable parameters, e.g. weights, in a plurality of layers. A replica of the neural network is maintained on each worker computer system.

Each worker computer system obtains training data for training the replica neural network maintained on the respective worker computer system. A worker computer system performs an inner optimization loop that involves training layers of the replica neural network maintained on the worker computer system for multiple time steps, to update the plurality of learnable parameters. An outer optimization loop is performed concurrently with the inner optimization loop. The outer optimization loop involves a succession of fragment updates each updating a different fragment of the replica neural network maintained on the worker system. Multiple fragment updates are performed during the time steps of the inner optimization loop.

In another aspect there is described a method of training a neural network using a distributed computing system. The distributed computing system comprises a plurality of worker computer systems, and the neural network comprising a plurality of learnable parameters, e.g. weights, in a plurality of layers.

A respective portion of the neural network is maintained on each worker computer system, the portion comprising a subset of the plurality of learnable parameters defining one or more experts, i.e. one or more neural network sub-models. Each sub-model can be a distinct part of the neural network comprising a specific subset of the learnable parameters.

Each worker computer system obtains training data for training the portion of the neural network maintained on the respective worker computer system. The worker computer system performs an inner optimization loop that involves training layers of the portion of the neural network maintained on the worker computer system for multiple time steps, to update the subset of learnable parameters. Concurrently with performing the inner optimization loop, the worker computer system performs an outer optimization loop that involves a succession of fragment updates, each updating a different fragment of the portion of the neural network maintained on the worker system. Updating a fragment involves synchronizing the learnable parameters of the fragment with a corresponding fragment maintained on a subset of the other worker computer systems.

In a further aspect there is described a method of training a neural network using a distributed computing system, in particular for eager updating. The distributed computing system comprises a plurality of worker computer systems, and the neural network comprising a plurality of learnable parameters, e.g. weights. A replica of the neural network is maintained on each worker computer system

The method involves a worker computer system performing a first inner optimization loop to update the plurality of learnable parameters and determine a first set of local gradients. The worker computer system initiates sharing of the first set of local gradients with the other worker computer systems, e.g. sending the first set of local gradients to the other worker computer systems.

The worker computer system also performs a second inner optimization loop to further update the plurality of learnable parameters, and determine a second set of local gradients. Performing the second inner optimization loop overlaps in time with the sharing of the first set of local gradients.

The worker computer system receives aggregate parameter update information derived from the first set of local gradients shared by the worker computer system, and local gradients shared by the other worker computer systems, and updates the plurality of learnable parameters using a combination of the second set of local gradients and the received aggregate parameter update information.

The various features of example implementations of the systems and methods described later may be included as further features in each of these aspects.

The subject matter described in this specification can be implemented in particular embodiments so as to realize one or more of the following advantages.

The described techniques, in particular those relating to streaming implementations, enable large neural networks to be trained in a distributed computing setting with reduced bandwidth connections between workers compared to some other approaches. In particular, whilst some techniques reduce the average bandwidth required for a connection it has been recognized that reducing the peak bandwidth is also important, and the described techniques can achieve this. An example implementation of the technique can train a 100B parameter neural network with a roughly constant bandwidth of only ~1-5 Gbit/s, some two orders of magnitude less than a data-parallel approach. This can be achieved whilst performing comparably in terms of training loss and downstream evaluation accuracy.

Implementations of the techniques also enable workers to continue training whilst synchronizing, which decreases wall clock training time.

The peak bandwidth can be still further reduced by the quantization of selected information as described herein.

Some implementations employ local memory management to reduce a memory overhead of using the described techniques.

The techniques can increase the compute utilization of training a large neural network, i.e. the proportion of time spent in computation rather than communication, and can reach 95%. This is in part because there is a latency reduction in splitting the outer optimization loop over multiple fragments.

Paradoxically, in implementations of the described techniques that overlap communication and computation the required communication bandwidth between workers can become lower as the neural network becomes larger. This is because a longer compute time (forward and backward passes) provides more time to synchronize the aggregate parameter update information across workers. This is particularly useful as it facilitates scaling to larger neural network sizes.

Distributed training often requires workers to wait for synchronization operations to complete before resuming computation. In settings where communication bandwidth is low or latency is high, such as when training across geographically dispersed data centers, this can lead to significant idle time and reduced compute utilization. Implementations of the described techniques facilitate the training of modular clusters or constellations of loosely connected models across heterogeneous devices, and can remove the constraint of co-located infrastructure for distributed training. This facilitates efficient use of compute availability spread world-wide, even when devices are geographically dispersed and not tightly coupled.

Implementations of the described techniques, in particular but not exclusively those relating to eager updating, enable workers to continue training without waiting for the communication of parameter updates to complete. By allowing the communication of gradients, e.g., in an outer synchronization loop, to overlap with the computation of a subsequent training phase, e.g., in an inner optimization loop, the system can hide the latency of the network. Again this allows for high compute utilization, approaching 100%, even on networks with very limited bandwidth, e.g., 1 Gbit/s or less.

Implementations of the described eager update mechanism can also ensure that this communications overlap does not come at the cost of model performance. By applying a local update immediately, allowing training to proceed, and then retroactively correcting the model state once global synchronization data arrives, the system can maintain convergence properties comparable to fully synchronous training. This again facilitates training very large models, e.g. 100 billion parameters or more, whilst relaxing requirements on infrastructure performance.

The techniques are also robust to heterogeneity in the distributed computing system. In particular because implementations of the techniques do not require all workers to finish communication at the same time the system can tolerate individual slow workers, or workers with varying computational speeds, without stalling the training process.

The combination of the described latency-hiding techniques with quantization, e.g., using low-precision communication, can further reduce the bandwidth requirements, and the overall saving can be some orders of magnitude by comparison with other data-parallel approaches. Again the techniques can be particularly useful when training very large models on widely distributed, loosely coupled hardware.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example distributed computing system for training a neural network.

FIG. 2 is a flow diagram of a first example process for training a neural network using a distributed computing system.

FIG. 3 illustrates two example fragmentation and streaming patterns for training a neural network.

FIG. 4 illustrates, schematically, an example implementation of the process of FIG. 2.

FIG. 5 is a schematic timing diagram that compares distributed training methods for training a neural network.

FIG. 6 is a timing diagram illustrating data flow and operations of an example training process that uses an eager updates mechanism.

FIG. 7 is a flow diagram of a second example process for training a neural network using a distributed computing system.

FIG. 8A, FIG. 8B, and FIG. 8C illustrate the scaling performance of various distributed training processes.

Like reference numbers and designations in the various drawings indicate like elements.

### DETAILED DESCRIPTION

Techniques are described for training a neural network, in particular a large neural network to perform a machine learning task. Some implementations of the techniques use a distributed computing system with multiple workers that work in parallel, connected by a computer network. As used herein, “training” includes fine tuning a pre-trained model.

The large neural network can have at least 10⁹ trainable parameters, such as weights; in some implementations at least 10¹⁰ or 10¹¹ trainable parameters. In general, the neural network is configured to process a neural network input in accordance with the trainable parameters, e.g. weights, of the neural network, to generate a neural network output that defines a result of a machine learning task. The neural network is also described herein as the “model”. As some examples, the neural network may comprise a so-called foundation model such as a large language model (LLM) or vision language model (VLM), or a diffusion model.

The described techniques are not limited to any particular type or architecture of neural network, and the neural network to be trained can have any appropriate architecture for performing a machine learning task. Examples of neural network architectures that the neural network can have include (but are not limited to): convolutional architectures, e.g. U-Net architectures, recurrent architectures, fully-connected architecture, e.g., multi-layer perceptron (MLP) architectures, generative (large) language model or multi-modal model architectures, e.g., encoder-only Transformer architectures, encoder-decoder Transformer architectures, decoder-only Transformer architectures, other attention-based architectures, diffusion and related model architectures, and so on; including any combination of these.

In some implementations of the described techniques, a shared set of the trainable parameters is maintained, and each of a geographically distributed set of workers updates their trainable parameters using a shard of a training dataset.

In some implementations, to reduce the peak bandwidth requirements of synchronizing such large models, the techniques involve synchronizing only subsets of parameters, referred to herein as “fragments”, in a sequence, rather than synchronizing all parameters at once. Also or instead, implementations of the techniques allow workers to continue training while synchronizing, decreasing wall clock time (“eager updates”).

Optionally the described techniques can also quantize the data that is exchanged over the computer network to further reduce bandwidth, e.g. communicating the data, in particular gradients, at a lower precision than that used for computation by the workers.

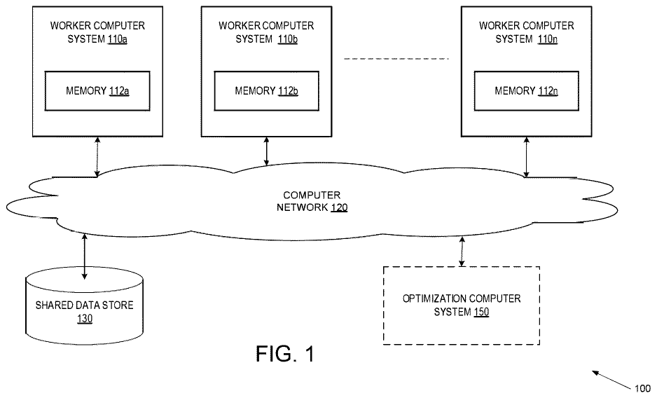

FIG. 1 shows an example of a distributed computing system 100 for training a neural network, in particular a large neural network. The distributed computing system 100 comprises a plurality of computing devices 110a..n, i.e. worker computer systems, each having associated local memory 112a..n. A worker computer system, also referred to herein as a “worker”, may comprise, as some examples: a general purpose computer system; or a computer with one or more machine learning hardware accelerators, e.g. that perform matrix multiplication in hardware, such as, a computer equipped with one or more GPUs (Graphics Processing Units) or TPUs (Tensor Processing Units); or a cluster of computers or of hardware accelerators, that can be tightly-connected.

Where a worker computer system comprises a cluster of devices the devices can have high bandwidth connections between them, with relatively lower bandwidth connections between the worker computer systems. The worker computer systems can have different computing or memory capabilities, or capabilities that vary over time.

The worker computer systems 110 are coupled by a shared computer network 120 and can operate in parallel. The computer network 120 may include wired and/or wireless parts and may comprise, e.g., a local area network (LAN), a wide area network (WAN), or the Internet. An advantage of the described techniques is that they are suitable for implementation in an environment in which the communications bandwidth is relatively limited, for example where devices are not co-located in the same physical cluster.

In this example distributed computing system each of the worker computer systems 110 maintains a replica of the neural network. Each replica of the neural network has the same neural network architecture, but can, in general, have different learned parameter values. As described later, subsets of the learned parameter values are effectively synchronized between the replicas at intervals, but in implementations this can be done by communicating information used for updating the learnable parameters rather than explicitly communicating learned parameter values. The replica of the neural network on each worker computer system can be initialized to have the same (initial) values for the plurality of learnable parameters. The distributed computing system 100 can include a shared data store 130, accessible over the computer network 120, used to maintain a shared set of values of the trainable parameters, or fragments thereof.

In some implementations the system includes an optimization computer system 150, which may be one of the computing devices 110 or a shared server, for performing parameter aggregation. In some implementations the system uses peer-to-peer communications and there is no separate optimization computer system 150. For example each of the worker computer systems 110 can communicate with each of the others.

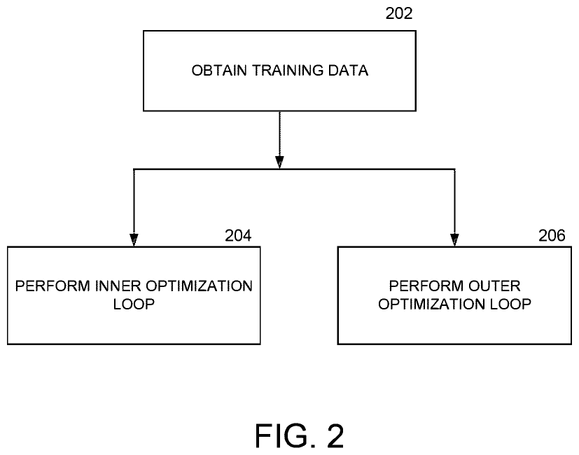

FIG. 2 is a flow diagram of a first example process for training a neural network using a distributed computing system, such as the distributed computing system 100 of FIG. 1.

Each worker computer system obtains training data for training the replica neural network that is maintained on the respective worker computer system (step 202). The replica neural network can be trained from scratch (random initialization) or fine-tuned, i.e. a previously trained version of the neural network can be further trained, e.g. to optimize a policy of the neural network.

In some implementations each worker computer system 110 obtains one of a plurality of shards of a training dataset for training the replica neural network. This can be maintained in a memory of the worker computer system.

A worker can be allocated a shard, e.g. by a server, or can obtain a shard of the training dataset, e.g. from a shared data store, without any form of central control. The shards of training data can be disjoint partitions of the training dataset, or the training data in the shards can overlap. That is, in some implementations each worker computer system can have different training data whilst in some other implementations some or all of the worker computer systems can share training data.

The process involves a worker computer system 110, in implementations each worker computer system, performing an inner optimization loop and an outer optimization loop. The or each, worker computer system can operate in parallel with some or all of the other worker computer systems.

In more detail, a worker computer system 110 performs an inner optimization loop (step 204) that involves training layers of the replica neural network maintained on the worker computer system for a plurality of time steps (inner optimization time steps), to update the plurality of learnable parameters of the neural network. That is, a training loop of the inner optimization loop has a duration of the plurality of inner optimization time steps, H.

In some implementations training layers of the replica neural network on the worker computer system can involve training all the layers of the replica neural network for the plurality of time steps, i.e. without holding the parameters of any layers, in particular non-shared layers, fixed. Whilst freezing the parameters of layers could in principle help when merging gradients (see later), it has been found that the computational inefficiency of the limited parameter updating in such an approach outweighs the potential benefit in a compute-bound setting.

Training the layers of the neural network using the inner optimization loop can involve backpropagating gradients of an objective function to update the learnable parameters of the neural network. This can use any appropriate gradient descent optimization algorithm, e.g. Adam or a variant thereof (e.g. Loshchilov et al., 2019), another optimization algorithm. The described techniques can be used to train the neural network to perform any task(s); and the objective function can be chosen accordingly. In general the objective function is the same for each of the worker computer systems. The objective function can be evaluated on the local data shard.

Concurrently with performing the inner optimization loop the process, in particular the worker computer system, performs an outer optimization loop (step 206). Whilst the inner and outer loops are performed concurrently, in implementations this can involve interleaving individual steps of the process.

The inner optimization loop and the outer optimization loop are running at the same time. However this does not necessarily, imply that one or more individual steps of the inner optimization loop are performed at the same time as one or more individual step of the outer optimization loop. For example, concurrently performing the inner and outer optimization loops can involve an interleaved approach, e.g. pausing computation, sending a packet, then resuming computation.

Performing the outer optimization loop involves performing a succession of fragment updates, each updating a different fragment of the replica neural network maintained on the worker system 110.

The (replica) neural network is partitioned into a plurality of fragments where a “fragment” comprises a subset of the learnable parameters. For example, the neural network generally comprises a plurality of layers and a fragment of the neural network can comprise the parameters of a subset of, i.e. less than all, the layers. Where the neural network comprises a Transformer neural network, a “neural network layer” for the purposes of fragmentation may comprise a Transformer block, i.e. an attention (or self-attention) layer followed by a feedforward layer and one or more normalization layers.

Multiple fragment updates are performed during the plurality of time steps of the inner optimization loop. In this way the fragment updates in the outer optimization loop are staggered so that successive different fragments of the neural network are updated in the outer optimization loop at different times during the inner optimization loop.

In implementations the process performs fragment updates more frequently than the plurality (H) of inner optimization time steps. In implementations any particular fragment is updated at intervals at least equal to a duration of the plurality of inner optimization time steps.

In some implementations the process, in particular the worker computer system, updates the fragment parameters by replacing the preceding values of the parameters, e.g. weights, of a fragment with the outer loop optimized values.

In some implementations the process continues to perform inner optimization loop computation (for updating the plurality of learnable parameters) whilst waiting for communication of aggregate parameter update information for updating the fragments. That is the worker can continue to perform inner optimization steps on the model (including the fragment being updated) so that the inner optimization loop computation and communication of the aggregate parameter update information can overlap in time.

For example, the inner optimization loop computations can continue whilst a worker computer system waits for aggregate parameter update information to be received, so that an outer optimization loop fragment update can be performed. In these implementations the process can merge the results of i) performing the inner optimization loop computation whilst waiting for communication of aggregate parameter update information, and ii) a fragment update determined from the aggregate parameter update information, after receiving the aggregate parameter update information for a fragment. For example parameter values optimized in the outer loop can be merged with further updated parameter values from the ongoing inner loop, for example using a mixing factor α.

In implementations performing a fragment update for a fragment involves the (each) worker computer system, at an outer optimization time step, determining a set of local gradients for a subset of the learnable parameters of the replica neural network corresponding to the fragment. The subset of the learnable parameters is a proper subset, i.e. less than all of the learnable parameters. The gradients are local to the worker computer system performing the inner optimization loop.

Determining the set of local gradients involves determining a difference between i) current values of the subset of the learnable parameters at a current time step of the fragment update for the fragment and ii) preceding values of the subset of the learnable parameters at a preceding time step of a preceding fragment update, e.g. an immediately preceding fragment update, for the fragment. The preceding time step can be, e.g., at least H time steps before the current time step.

That is, the current values of the fragment parameters (the subset of the learnable parameters for the fragment) are from performing the inner loop optimization. In some implementations the aforementioned difference results from the inner optimization loop training all the layers of the replica neural network maintained on the worker computer system.

The worker computer system shares the set of local gradients by sending the set of local gradients to each of the other worker computer systems or to a server (depending upon the implementation).

The worker computer system receives aggregate parameter update information from the other worker computer systems or from the server. The aggregate parameter update information may comprise, e.g., a set of local gradients for the fragment from each of the other workers (entailing local aggregation); an aggregate, e.g., average, of the local gradients calculated by a server; or a set of updated values of the subset of learnable parameters received from the server, e.g. where the server maintains and updates global parameter values.

In more detail, in some implementations the aggregate parameter update information comprises a set of local gradients for the fragment from each of the other worker computer systems. Then gradient aggregation can be performed locally at the worker computer system, as described later. Such a system does not need a central server.

In some implementations the aggregate parameter update information is received from the server. The aggregate parameter update information can then comprise an aggregate, for the fragment, of a set of the local gradients determined by each of the worker computer systems. That is, the gradient aggregation can be performed at the server and then an aggregate of the gradients sent to the (each) worker computer system. In this context a “server” can include one of the worker computer systems acting as the server.

In some implementations the aggregate parameter update information comprises a set of updated values of the subset of the learnable parameters, received from the server, i.e. values updated using an aggregate, for the fragment, of a set of the local gradients determined by each of the worker computer systems. That is the server can maintain a set of the plurality of learnable parameters for the neural network, can determine an aggregate of the gradients from each worker computer system, and can also update the fragment parameters using the determined aggregate and send these updated fragment parameters to the worker computer system(s) as the aggregate parameter update information. Again, one of the worker computer systems can act as the server.

The fragment parameter updating in the outer optimization loop can be performed by each individual worker computer system or by a server. In either case this can be referred to as synchronization of the fragment parameters, or synchronization of the replicas.

The worker computer system can update its subset of the learnable parameters of the replica neural network corresponding to the fragment using the aggregate parameter update information.

For example the worker computer system can determine an aggregate of the set of the local gradients determined by each of the worker computer systems, or can have received this, e.g. from a server, and can use this to update its subset of the learnable parameters for the fragment. Alternatively the worker computer system can receive updated values for the subset of the learnable parameters for the fragment, e.g. from the server, and use these directly in its replica neural network.

As previously described, in implementations the worker computer system obtains an aggregate, for the fragment, of the set of the local gradients determined by each of the worker computer systems, either determining this locally or receiving the aggregate, e.g. from a server.

In some implementations the aggregate of the set of the local gradients determined by each of the worker computer systems can be an average of the set of the local gradients determined by each of the worker computer systems.

The worker computer system can apply the aggregate of the set of the local gradients to the preceding values of the subset of the learnable parameters to obtain outer loop optimized values for the subset of the learnable parameters for the fragment, i.e. values that are a result of the outer loop optimization. More specifically, the outer loop optimized values can be obtained by taking the preceding values of the subset of the learnable parameters for the fragment, at the preceding fragment update, and applying the aggregate of the set of the local gradients (using any suitable optimizer) to update the preceding values for the fragment to obtain the outer loop optimized values.

The worker computer system 110 can update the subset of the learnable parameters of its replica neural network corresponding to the fragment, using the outer loop optimized values. As described further below, one way this can be done is by using the outer loop optimized values as the subset of the learnable parameters for the fragment, e.g. replacing (current) values of the subset of the learnable parameters. Alternatively this can be done by merging the outer loop optimized values into the subset of the learnable parameters for the fragment.

Any suitable optimizer can be used to obtain the outer loop optimized values for the subset of the learnable parameters. In some implementations a Nesterov optimizer, i.e. an optimizer using Nesterov momentum, is employed (Sutskever et al., “On the importance of initialization and momentum in deep learning”, ICML, 2013). For example a Nesterov optimizer can first update its momentum with an exponential moving average (EMA), or “decay”, of its previous momentum and the (outer loop) gradient, and then compute the (outer loop) update using another exponential moving average, or “decay”, of its previously updated momentum and the (outer loop) gradient.

For example an update of fragment parameters θ_{old} to θ_{new}, using an EMA version of Nesterov momentum can be determined as:

$$\begin{matrix}μ = ( 1 - β ) μ + β \cdot Δ \\ outer\_update = ( 1 - {β}^{′} ) μ + {β}^{′} \cdot Δ \\ {θ}_{new} = {θ}_{old} - η \cdot outer\_update\end{matrix}$$

where μ denotes momentum, β, β′∈[0,1) are decay coefficients (that may be the same), Δ denotes the aggregated gradients, and η a learning rate. As another example a “decay version” of a Nesterov optimizer can accumulate momentum without the (1−β) factor, e.g. as μ=3β·μ+Δ and outer_update=Δ+β′·μ.

As previously described, in some implementations updating the subset of the learnable parameters of the replica neural network corresponding to the fragment using the outer loop optimized values involves replacing the preceding values of the subset of the learnable parameters for the fragment with the outer loop optimized values.

In some implementations the inner and outer optimization loops can be overlapped, e.g. by overlapping communication of the aggregate parameter update information and performing the computations of the inner loop optimization.

For example this can involve continuing to perform the inner optimization loop whilst performing the outer optimization loop, to determine further updated values for the subset of the learnable parameters for the fragment from the inner optimization loop, e.g. whilst waiting to fully receive the aggregate parameter update information. That is, this can involve continuing to perform the inner optimization loop whilst waiting to receive, or receiving, the aggregate parameter update information. This can enable the system to immediately start a next outer optimization loop after finishing a preceding inner optimization loop, although the system does not necessarily do this.

In some implementations the worker computer system continues to perform the inner optimization loop for an overlap number of time steps (τ) of the inner optimization loop whilst waiting to receive or receiving the aggregate parameter update information. The overlap number of time steps can be a predetermined number of time steps, e.g. less than the plurality of time steps in the inner optimization loop, H. After performing the inner optimization loop for the overlap number of time steps the worker computer system can wait until the aggregate parameter update information is (fully) available before proceeding.

When the inner and outer optimization loops are overlapped updating the subset of the learnable parameters of the replica neural network corresponding to the fragment using the outer loop optimized values can involve merging the outer loop optimized values and the further updated values for the subset of the learnable parameters for the fragment. For example, the merging can involve summing the further updated values with a weight α, and the outer loop optimized values with a weight (1−α).

As previously described, in some implementations obtaining (for a fragment) the aggregate of the set of the local gradients determined by each of the worker computer systems involves the worker computer system receiving the set of local gradients for the fragment from each of the other worker computer systems, and aggregating, e.g. averaging, the set of local gradients for the subset of the learnable parameters of the replica neural network corresponding to the fragment and the set of local gradients for the fragment received from each of the other worker computer systems. That is, the aggregation of the gradients can be done locally, by each of the worker computer systems.

In implementations of the described techniques the inner optimization loop is performed at least once between each updating of a particular fragment of the replica neural network.

In implementations the current time step is at least the plurality of time steps of the inner optimization loop (H) after the preceding time step. A time difference between the current time step and the preceding time step can be equal to or greater than a duration of the plurality of time steps of the inner optimization loop. That is in implementations the same fragment is not updated more than once in a single inner optimization loop (but it can be updated once each inner optimization loop).

In some implementations a difference between the current time step and the preceding time step is equal to the plurality of time steps of the inner optimization loop. For example, each fragment can be updated every H time steps. If there are p fragments a fragment update can be performed every p/H (inner optimization) time steps. For example, the system, e.g. a worker computer system 110, can determine whether a specific fragment p is due for an update. This can be determined by a schedule, for example, if a current time step t satisfies a condition t−tₚ\modH==0, where tₚ is a time offset specific to fragment p. If a fragment is due for update, the worker determines a set of local gradients, i.e. an “outer gradient” for that fragment. This can be determined by the difference between the current values of the parameters in the fragment and the values of those parameters at the preceding synchronization of that fragment.

In principle the different fragments of the replica neural network could comprise successive random choices of weights or layers, e.g. according to some distribution that is useful for optimization. In general, however, the different fragments of the replica neural network comprise different predetermined subsets of the plurality of layers of the neural network.

In some implementations the plurality of layers of the neural network comprises a sequence of neural network layers and the different subsets of the plurality of layers comprise groups of consecutive neural network layers in the sequence. That is, the fragments can be sequential groups of layers of the neural network.

In some implementations the plurality of layers of the neural network comprises a sequence of neural network layers, and the different subsets of the plurality of layers comprise groups of interleaved neural network layers in the sequence. That is the neural network layers in the different fragments can be interleaved with one another so that the fragments are strided.

As previously described, in some implementations the neural network comprises a Transformer neural network, i.e. a neural network comprising a stack of Transformer blocks. As used herein a neural network layer includes a Transformer block. A Transformer block typically includes an attention or self-attention neural network layer followed by a feedforward neural network layer, and often one or more normalization layers. In general a self-attention neural network layer applies a self-attention operation, e.g. a query-key-value (QKV) self-attention operation, to elements of an embedding, to update each element of the embedding.

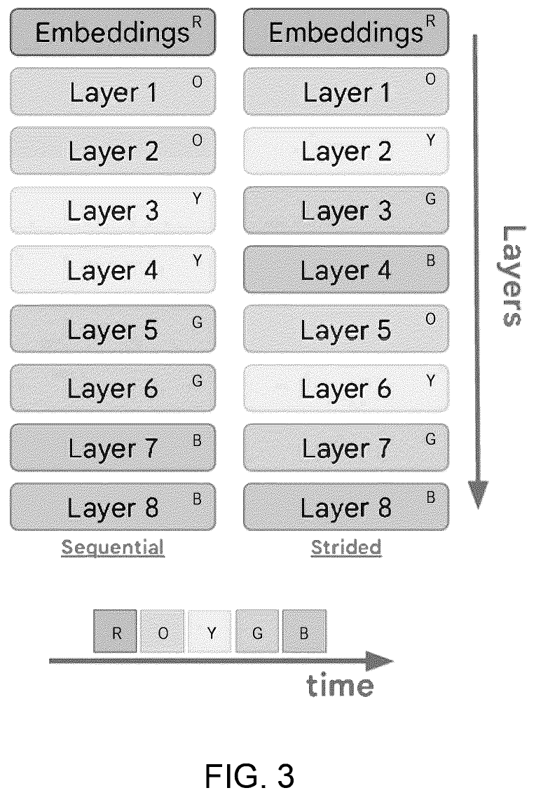

FIG. 3 illustrates two example fragmentation and streaming patterns of a Transformer neural network. The Transformer neural network comprises eight consecutive blocks (“layers”) and an initial embedding layer, e.g. an input/output embedding matrix that maps between input/output tokens of the model and vectors processed by the model. Each different color denotes a different fragment, and the different colors along the time axis denote which fragment of the neural network is subject to the outer optimization loop, i.e. is being synchronized, during a particular time interval. In FIG. 3 the colors are labelled R (red), orange (O), yellow (Y), green (G), and blue (B).

The configuration on the left illustrates a sequential pattern in which a first fragment comprises a first set of consecutive layers (e.g., layers 1 to N), and a subsequent fragment comprises a next set of consecutive layers (e.g., layers N+1 to 2N), where N=2 in the illustrated example. The colors along the time axis indicate a sequential update pattern.

The configuration on the right illustrates a strided pattern in which each fragment comprises the learnable parameters corresponding to layers that are interleaved throughout the depth of the neural network. For example, a first fragment may comprise every Pth layer of the neural network (e.g., layers 1, 1+P, 1+2P, . . . ), while a second fragment comprises the subsequent interleaved layers (e.g., layers 2, 2+P, 2+2P, . . . ), where P=4 in the illustrated example. The colors along the time axis indicate a strided update pattern.

Experimentally it has been found that using a strided pattern can provide slightly better compute optimization. For example, when overlapping communicating the set of local gradients with performing the inner optimization loop the updated parameters can be distributed more evenly across the computation graph, i.e. across the depth of the neural network.

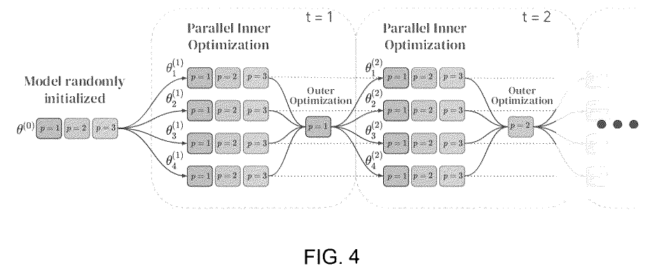

FIG. 4 illustrates, schematically, an example implementation of the process of FIG. 2. In this example there are 4 worker computer systems, i.e. 4 neural network replicas each with a respective step of model parameters θ, i.e. θ₁, θ₂, θ₃, θ₄. Each neural network replica has fragments labelled by p, where here p={1, 2, 3}. In the illustration each fragment has a different color. Each fragment can comprise, e.g., a plurality of Transformer neural network layers. Each time step t denotes a full cycle of an inner optimization loop, typically dozens of inner optimization steps. These inner loops are executed in parallel by the worker computer systems 110, followed by an outer optimization loop step synchronization occurs. Superscripts on the model parameters θ denote the time step.

As can be seen, instead of synchronizing the entire model at once, the worker computer systems initiate sharing of the set of local gradients for only a single fragment at a time (e.g., the red fragment, p=1 is synchronized first, followed by the blue fragment, p=2). This “streaming” of partial updates allows the outer optimization loop to be performed sequentially on subsets of the model, distributing the communication load over time and reducing peak bandwidth requirements while allowing the worker computer systems to continue training the other fragments independently.

To further reduce communications bandwidth of communications from/to the worker computer systems some implementations of the system involve determining the set of local gradients for the subset of the learnable parameters of the replica neural network corresponding to the fragment using arithmetic of a first precision, e.g. FP32. However the set of local gradients is sent to each of the other worker computer systems, or to the server, at a second, lower precision. The lower precision can be, e.g., 8 bit or 4 bit precision, e.g., E3M0 (3 bit exponent, 0 bit mantissa i.e. no mantissa, and a sign bit). Similarly the received aggregate parameter update information can also be at the lower precision. The second, lower precision can be a quantization of the first precision.

In implementations the aggregating of the set of local gradients is still performed at the first, higher precision, i.e. when aggregating gradients for the subset of the learnable parameters of the replica neural network corresponding to the fragment and the set of local gradients for the fragment received from each of the other worker computer systems. This can assist with stability of the training process.

In the context of the above described system the efficiency of the computations performed by a worker computer system 110 can be improved, and in particular the efficiency of memory utilization, can be improved by storing the learnable parameters of the replica neural network corresponding to the different fragments in first memory of a worker computer system, e.g. CPU RAM. When performing the fragment update for a particular fragment, the subset of the learnable parameters of the replica neural network corresponding to the fragment can be selectively loaded into second memory of the worker computer system, where the second memory has a higher memory access bandwidth (by a processor of the worker computer system) than the first memory. For example the second memory can be HBM (High Bandwidth Memory), e.g. of a GPU, TPU or similar.

Further, transfer of data for a fragment from the first memory to the second memory can be started whilst finishing a (previous) inner optimization loop. This data can comprise learnable parameters of the fragment and, optionally, a state, e.g. a momentum state, of the outer loop optimizer.

In more detail, implementing the outer optimization loop can impose an additional memory requirement equal to the number of outer, i.e. global parameters, each with a corresponding momentum, e.g. Nesterov state. However only a subset of these outer parameters is needed at any one time, in particular the size of a fragment times two (parameters and outer optimization state). These can be held in HBM and the rest can be offloaded into CPU memory. The additional HBM memory requirement is typically small, e.g. around 2% for a three layer fragment of a 108 layer model. The transfer of a fragment into HBM can be started whilst finishing the previous (inner) gradient passes. Again this can involve minimal latency, e.g. around 10 ms for 20 GB at 2 TB/s, to continue the previous example.

The algorithm below shows one example implementation of the above-described process:

```
Require: M replicas
Require: Number of inner steps H
Require: Fragments p ϵ (1, . . . , P} with their
  respective synchronization offset tₚ
$Require \text{:} Model replicas \{ {θ}_{1}^{( t )} , … , {θ}_{M}^{( t )} \}$
Require: Inner overlap delay τ < H
Require: Data shards { [symbol]  , . . . , [symbol]  }
Require: Optimizers InnerOpt and OuterOpt
  1: parallel for replica m = 1 . . . M do
  2: for step t = 1 . . . T do
  3: x ~ [symbol]
  4:  $ℒ ← f ( x , {θ}_{m}^{( t - 1 )} )$
  5:  ${θ}_{m}^{( t )} ← InnerOpt ( {θ}_{m}^{( t - 1 )} , {∇}_{ℒ} )$
  6: if ∃p s.t. t − tₚ mod H = = 0 then
  7:  ${Δ}_{m , p}^{( t )} ← {θ}_{m , p}^{( t - H )} - {θ}_{m , p}$
  8:  ${Δ}_{p}^{( t )} ← async - send [ \frac{1}{M} {\sum }_{m = 1}^{M} ( {Δ}_{m , p}^{( t )} ) ]$
  9: if ∃p s.t. t − tₚ − τ mod H = = 0 then
10:  $block - receive [ {Δ}_{p}^{( t - τ )} ]$
11:  ${\tilde{θ}}_{m , p}^{( t )} ← OuterOpt ( {θ}_{m , p}^{( t - τ - H )} , {Δ}_{p}^{( t - τ )} )$
12:  ${θ}_{m , p}^{( t )} ← {αθ}_{m , p}^{( t )} + ( 1 - α ) {\tilde{θ}}_{m , p}^{( t )}$
13: end parallel for
```

The process initiates M parallel replicas, each running for a total of T steps (lines 1-2). At each step t, the worker samples a batch of data x from its local shard [symbol] , computes the loss [symbol] and updates its local parameters

$${θ}_{m}^{( t )}$$

using the inner optimizer, e.g., AdamW (lines 3-5).

The worker computer system checks whether a specific fragment p is scheduled for synchronization at the current step t, based on the condition t−tₚmodH==0. If so, it calculates the outer gradient

$${Δ}_{m , p}^{( t )}$$

for that fragment by comparing the current parameters to their state H steps ago. The worker computer system then initiates an asynchronous transmission of the average of these gradients across all M replicas (lines 7-9). The worker computer system does not wait for the block-receive (it operates asynchronously), instead it immediately starts the next round of (inner) optimization.

The worker computer system checks if a fragment sent τ inner loop iterations ago is ready to be received, i.e. it determines whether time t satisfies the condition t−tₚ−τ\modH==0. If so the process performs a block-receive (line 10), which requires the worker to pause the inner optimization loop until the aggregated gradient

$${Δ}_{p}^{( t - τ )}$$

is received. Ideally, by delaying this blocking event for τ steps (the overlap period), even if the computer network 120 is relatively slow, the aggregated gradient is present by the time the worker performs the block-receive, so that the pause is instantaneous, i.e. has zero duration, and compute utilization can remain at 100%.

Once the aggregated gradient received the worker computer system then calculates a new parameter state

$${\tilde{θ}}_{m , p}^{( t )}$$

by applying the outer optimizer (line 11), e.g., using Nesterov momentum, to the parameters as they existed before the delay

$$( {θ}_{m , p}^{( t - τ - H )} ) .$$

Finally, it updates the current fragment parameters

$${θ}_{m , p}^{( t )}$$

by merging the current local state with the global update using a mixing factor α (line 12). This merging step allows the worker to benefit from the global synchronization while retaining the “eager” progress made during the overlap period τ.

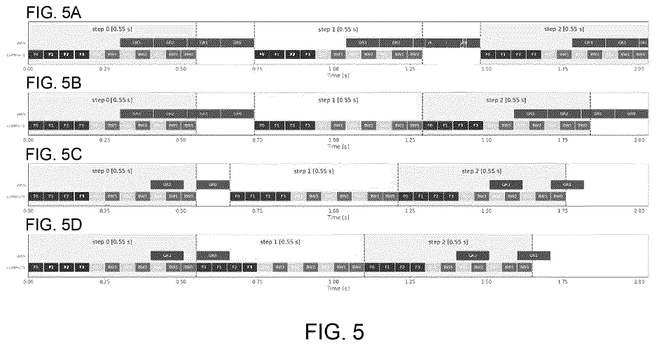

FIG. 5 is a schematic timing diagram that compares distributed training methods for training a toy neural network, including example implementations of the process of FIG. 2. The horizontal axis represents time (in seconds), illustrating the sequence and duration of operations, and the bars represent particular operations performed by one of the worker computer systems 110 (each of the worker have the same schedule, in a Single Program Multiple Data configuration).

The blue bars (F0, F1, F2, F3) represent a forward pass through a four layer neural network (computing activations); light green bars (BA1, BA2, BA3) represent a backward pass through the neural network with respect to activations (backpropagating the gradients of the loss to the input of a layer), and dark green bars (BW0, BW1, BW2, BW3) represent a backward pass with respect to weights (calculating gradients with respect to learnable parameters, e.g. weights, of a layer). Purple bars (GR0, GR1, GR2, GR3) represent gradient reduction i.e. the transmission of parameter update information across a WAN computer network 120, and aggregation of the parameter update information. The “WAN” row represents communication on the WAN; the “compute” row represents activity on the worker computer system

In FIG. 5 the distributed training is modelled as a directed acyclic graph in which the total number of nodes for a single optimization step is 4×L−1 where L is the number of layers in the neural network (a forward pass, two backwards passes, and a gradient reduction; the first layer does not backpropagate gradients of the loss to the input of that layer).

FIGS. 5A-5D illustrate the execution of nodes on this graph over time. In particular FIG. 5A illustrates a data parallel approach in which at every time step, e.g., “step 0”, “step 1”, a worker performs the forward and backward passes and in which, after the computation of the gradients, the worker pauses and performs a global communication step (GR) to synchronize the gradients across the model. Time is spent waiting for gradient communication at each step.

In FIG. 5B the worker performs multiple inner optimization loops (e.g. step 0 and step 1) independently without communicating. Communication occurs only after a fixed number of steps, as illustrated, H=2. This reduces the frequency of outer gradient communication (the WAN row) but involves exchanging the outer gradients for the entire neural network at one time. This creates a spike in the bandwidth requirement or, if bandwidth is limited, a significant delay in training.

In FIG. 5C, which is a first example implementation of the process of FIG. 2, there are two fragments each with two layers, only a fragment of the model is synchronized at a time (GR2 and GR0 at step 0; GR3 and GR1 at step 1; i.e. strided). A fragment update is performed every H=2 steps, and the communication wait time (WAN row) is significantly reduced, although not to zero.

In FIG. 5D, which is a second example implementation of the process of FIG. 2, the gradient communication for the fragments (WAN row) initiated at the end of step 0 overlapped in time with the computation (compute row) of subsequent step 1. The transmission happens in the background, while the worker is busy performing the next inner optimization loop, and the wait time can be reduced to zero, achieving approximately 100% compute utilization. In the toy example of FIG. 5D, τ=1.

Counter-intuitively in a process of the type shown in FIG. 5D, in which communication and computation are overlapped, the required bandwidth of the computer network 120 can reduce as the model size increases. This is because a longer compute step time (forward and backward) provides more time to perform the synchronization across the worker computer systems. This is a very significant advantage of some implementations of the described techniques.

In the implementations described above, each worker computer system 110 generally maintains a full replica of the neural network parameters θ. However, the described techniques are not limited to fully replicated models and in some alternative implementations the system may be configured as a distributed mixture-of-experts, e.g. a “modular constellation” of smaller models, optionally implemented using a so-called constellation of computers. Examples of such distributed mixture-of-experts models are described in Dean, “Introducing Pathways: A next-generation AI architecture”, Google blog, 2021; and in Douillard et al. arXiv:2403.10616, March 2024.

In such an implementation, the plurality of learnable parameters can be partitioned into distinct subsets, or “experts”, and different subsets of the worker computer systems can be assigned to train different experts. In this context an expert can be a neural network sub-model, i.e. a distinct part of the larger neural network comprising a specific subset of the learnable parameters. In particular, such a sub-model may be configured or trained to process specific subsets of inputs, e.g. specific tokens, or features, functioning as a specialized module within the larger neural network architecture.

Rather than synchronizing the entire model across all workers, the streaming synchronization process described can be adapted to synchronize a specific fragment, or expert, e.g. only among the subset of workers responsible for that fragment. This allows loosely connected modules to be trained across heterogeneous computing devices, i.e. devices with varying compute capabilities or memory bandwidths. By reducing the communication requirement to infrequent, low-bandwidth updates of specific fragments, this can facilitate the training of extremely large scale models spread across a diverse, e.g. world-wide, collection of available hardware resources rather than requiring a monolithic supercomputer.

The previously described streaming-based techniques can be adapted to such an approach by maintaining portions or subsets of the model, e.g. representing a specific expert, on each worker computer system, rather than a full replica of the neural network. Then synchronization can take place with just a subset of the other worker computer systems, i.e. with other worker computer systems that hold a copy of the same expert. Other features of the distributed streaming-based training, as described above, can be incorporated into the system. If the difference between processing times of different worker computer systems maintaining different experts is very large, e.g. exceeding the overlap period, asynchronous training techniques can also be used to accommodate slower workers, e.g. as described in Liu et al., arXiv:2401.09135.

Aspects of the above described techniques can be used independently of one another. For example asynchronous synchronization with speculative local progress and retroactive correction, which is referred to herein as an “eager update”, can be used independently of sequentially synchronizing parameter updates of fragments of a neural network.

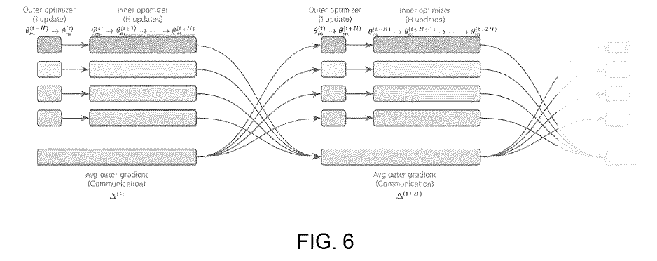

FIG. 6 is a timing diagram illustrating the data flow and operations of an example training process that uses an eager updates mechanism. This process can be implemented on a distributed computing system, such as the distributed computing system 100 of FIG. 1. The eager updates mechanism allows communication to overlap with computation, in particular delaying outer gradients, to break the blocking dependency between synchronization and computation.

In FIG. 6 the four horizontal timelines represent the concurrent activity of four worker computer systems over time, in the example each maintaining a respective replica of the neural network to be trained.

During the training each of the four workers performs a first inner optimization loop, labeled “Inner optimizer (H updates)” (left) for a duration of H inner optimization loop time steps, e.g., steps t−H to t). During this phase, each worker independently updates its learnable parameters using an inner optimizer on its local data shard. At the end of this first inner optimization loop, a set of outer gradients is determined for each worker, Δ^{(t)}.

The workers then initiate a sharing operation to distribute and average these outer gradients, represented by the bottom gray bar labeled “Avg outer gradient (Communication)”. The workers do not wait for this sharing to complete before continuing to train. Instead, each worker immediately begins a second inner optimization loop, again labeled “Inner optimizer (H updates)” (right), to further update the learnable parameters.

The sharing operation and the associated receipt of global data occur during a communication interval. As indicated by the vertical alignment in the diagram, the second inner optimization loop overlaps in time with the communication interval (the bottom grey bar). The second inner optimization loop is started without waiting for the communication to complete. FIG. 6 illustrates that the communication of an outer gradient update can, potentially, take as long as an entire inner optimization loop, which may be hundreds of inner loop steps. This can hide the communication cost even on very slow networks.

At the end of the next communication interval, the workers have received the aggregate parameter update information, e.g. Δ^{(t+H)}. Because the communication was overlapped with the execution of the next inner loop, this aggregate information corresponds to the gradients from the previous inner loop, a delay of one outer step. Each worker applies this delayed global update while also using its fresh local gradients to mitigate the staleness caused by the delay.

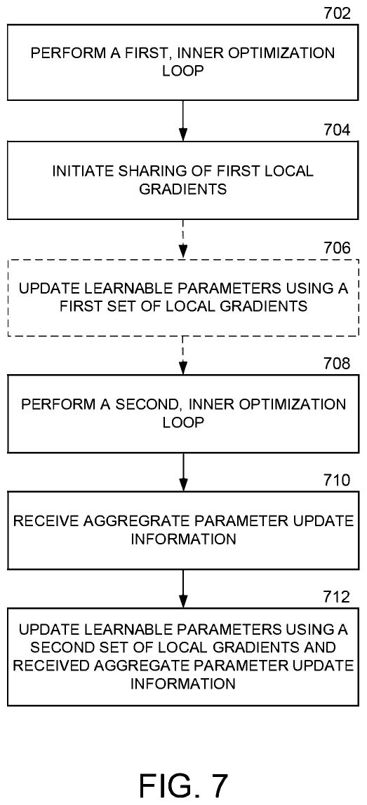

FIG. 7 is a flow diagram of a second example process for training a neural network using a distributed computing system, such as the distributed computing system 100 of FIG. 1. The process shows steps performed by one of the worker computer systems; each of the other worker computer systems can perform a corresponding process. The example process of FIG. 7 uses eager updates without fragmentation of the neural network.

At step 702, the worker computer system performs a first inner optimization loop, e.g. as previously described, to update the learnable parameters, and determines a first set of local gradients. Determining the local gradients may be performed using a first numerical precision, such as FP32 (32-bit floating point).

At step 704, the worker computer system initiates sharing of these first local gradients, sending them to the other worker computer systems. In some implementations, this sharing involves quantizing the gradients to a second, lower precision, e.g., FP4, 4-bit floating point, Int8, or E3M0, before sending them over the computer network 120. This can significantly reduce the bandwidth required for the sharing step.

At step 708, the worker computer system performs a second inner optimization loop e.g. as previously described, to further update the parameters. This step is performed overlapping in time with the sharing initiated in step 704. The duration of this second loop need not be identical across all workers; the method tolerates heterogeneity where some workers may take longer to complete their loops than others.

In some basic implementations the system, in particular the worker computer system, can simply wait until the delayed global gradients arrive and apply them. Optionally, however, prior to performing the second inner optimization loop in step 708, the process can include an update step 706 (omitted in the basic implementation). In step 706, the worker updates the plurality of learnable parameters using the first set of local gradients. In this update the local outer gradient serves as a proxy for the delayed global update. Including such an update step can improve parameter convergence during training, and can also improve training stability.

At step 710, the worker computer system receives aggregate parameter update information derived from the first set of local gradients and gradients from other workers. In some applications, e.g. where there is high-latency, this information could correspond to an inner optimization loop performed two or more cycles prior to the current loop.

At step 712, the worker computer system updates the learnable parameters, e.g. weights, using a combination of the results of the second inner loop, i.e. a second set of local gradients, and the received aggregate parameter update information.

Updating the plurality of learnable parameters can involve calculating a corrected update by adding the received aggregate parameter update information and subtracting the first set of local gradients. The corrected update can then be applied to the plurality of learnable parameters. This decouples the local gradient contribution from the delayed global gradient, allowing the model to benefit from global synchronization without double counting the local contribution or being penalized by the staleness of the global data.

In some implementations the second inner optimization loop is performed in its entirety without waiting for the receiving of the aggregate parameter update information to complete. This can allow the system to achieve close to 100% compute utilization by effectively hiding the communication latency behind the computation of the inner loop.

In some implementations the plurality of learnable parameters corresponds to a fragment of the neural network and a succession of outer optimization loops can be performed, each updating a different fragment of the neural network in a sequence. As previously described, this can substantially reduce the bandwidth requirements. As previously described, the first set of local gradients can be determined using a first numerical precision, and sent at a second, lower numerical precision. For example, gradients may be computed in FP32 but transmitted in FP4, 4-bit floating point, Int8, or E3M0. This quantization can significantly reduce the volume of data transmitted to further reduce the bandwidth requirements but, in experiments, has minimal impact on model training, e.g. <0.12% loss difference.

Some implementations of the process update the plurality of learnable parameters using the first set of local gradients prior to performing the second inner optimization loop. In this “eager” update the local gradient serves as a proxy for the delayed global update. Applying this local update immediately can improve training stability and convergence speed compared to a basic overlap approach (where the model trains on slightly stale weights).

The duration of the second inner optimization loop can be different for at least one worker computer system compared to another worker computer system in the distributed computing system. The technique tolerates system heterogeneity, e.g. the inclusion of relatively slower workers, or variable network latencies, because faster workers are not forced to idle whilst waiting for slower workers to reach the synchronization point.

In some implementations, updating the plurality of learnable parameters using the aggregate parameter update information involves applying an outer optimizer to the aggregate parameter update information, and maintaining a state of the outer optimizer on the worker computer system. This helps to distribute the memory and computational burden, helping the technique to scale efficiently with the number of workers; it can also help to avoid the bottleneck of a central parameter server.

Some implementations of the process store the first set of local gradients or the aggregate parameter update information in a first memory, e.g. CPU RAM, and load it into a second, higher-bandwidth memory, e.g. GPU or TPU HBM, only when performing the updating step. This helps to optimize memory resource usage by allowing for more efficient use of limited high-bandwidth memory, freeing up capacity for larger model parameters or batch sizes during the computation-heavy inner loop.

In some implementations, the received aggregate parameter update information corresponds to an inner optimization loop performed at least two cycles prior to the second inner optimization loop. This capability allows the system to tolerate extreme network latencies or overlap communication across multiple inner loops, e.g. up to 4.8 seconds in some experiments without stalling training.

The algorithm below shows a first, basic example implementation of the above-described eager updates process:

```
Require: M replicas
Require: Synchronization frequency H
$Require \text{:} Model replicas \{ {θ}_{1}^{( 0 )} , … , {θ}_{M}^{( 0 )} \}$
Require: Data shards { [symbol]  , . . . , [symbol]  }
Require: Optimizers InnerOpt and OuterOpt
  1: parallel for replica m = 1 . . . M do
  2: for step t = 1 . . . T do
  3: x ~ [symbol]
  4:  $ℒ ← f ( x , {θ}_{m}^{( t - 1 )} )$
  5:  ${θ}_{m}^{( t )} ← InnerOpt ( {θ}_{m}^{( t - 1 )} , {∇}_{ℒ} )$
  6: if t mod H = = 0 then
  7:  ${Δ}_{m}^{( t )} ← {θ}_{m}^{( t - H )} - {θ}_{m}^{( t )}$
  8:  ${Δ}^{( t )} ← async - send [ \frac{1}{M} {\sum }_{m = 1}^{M} ( {Δ}_{m}^{( t )} ) ]$
  9: if t > H then
10: block-receive[Δ^{(t-H)}]
11:  ${θ}_{m}^{( t )} ← OuterOpt ( {θ}_{m}^{( t - H )} , {Δ}^{( t - H )} )$
12: end if
13: end if
14: end for
15: end parallel for
```

In this example implementation gradient communication is overlapped with computation, but without a gradient correction that accounts for the delayed global update.

In more detail, at every inner optimization step t, the worker trains on its local data using the inner optimizer, e.g. Adam or a variant thereof (lines 3-5). At the end of an inner loop (every H steps), the worker calculates the local outer gradient

$${Δ}_{m}^{( t )}$$

representing the progress made during that loop (lines 6-8). It initiates an asynchronous send of this gradient to be averaged with other workers but does not wait for this result instead immediately proceeds to the next inner steps (looping back to line 3). The worker only waits to receive the aggregated gradient Δ^{(t-H)} from the previous cycle after the current inner loop is finished, i.e., when t>H (lines 9-11). It then updates the parameters using this global gradient, which corresponds to the state of the model H steps ago, applying this to the current model state (which has advanced by another H steps).

The algorithm below shows a second, improved example implementation of the above-described eager updates process:

```
Require: M replicas
Require: Synchronization frequency H
$Require \text{:} Model replicas \{ {θ}_{1}^{( 0 )} , … , {θ}_{M}^{( 0 )} \}$
Require: Data shards { [symbol]   , . . . , [symbol]  }
Require: Optimizers InnerOpt and OuterOpt
  1: parallel for replica m = 1. . . M do
  2: for step t = 1 . . . T do
  3: x ~ [symbol]
  4:  $ℒ ← f ( x , {θ}_{m}^{( t - 1 )} )$
  5:  ${θ}_{m}^{( t )} ← InnerOpt ( {θ}_{m}^{( t - 1 )} , {∇}_{ℒ} )$
  6: if t mod H = = 0 then
  7:  ${Δ}_{m}^{( t )} ← {θ}_{m}^{( t - H )} - {θ}_{m}^{( t )}$
  8:  ${Δ}^{( t )} ← async - send [ \frac{1}{M} {\sum }_{m = 1}^{M} ( {Δ}_{m}^{( t )} ) ]$
  9: if t > H then
10: block-receive[Δ^{(t-H)}]
11:  ${\tilde{Δ}}_{m}^{( t )} ← \frac{1}{M} ( {Δ}_{m}^{( t )} - {Δ}_{m}^{( t - H )} ) + {Δ}^{( t - H )} .$
12:  ${θ}_{m}^{( t )} ← OuterOpt ( {θ}_{m}^{( t - H )} , {\tilde{Δ}}_{m}^{( t )} )$
13: end if
14: end if
15: end for
16: end parallel for
```

In this example, as in the previous, basic implementation, the worker initiates the send at line 8 and immediately continues training, performing the above described second inner optimization loop. In this way it implicitly applies its own local gradient Δₘ to the model. However when the delayed global aggregate Δ^{(t-H)} eventually arrives, the algorithm calculates a corrected gradient, [symbol] (line 11).

In the example algorithm calculating the corrected gradient involves taking the current local gradient

$${Δ}_{m}^{( t )}$$

((fresh), subtracting the previous local gradient

$${Δ}_{m}^{( t - H )}$$

(stale), and adding the previous global aggregate Δ^{(t-H)} (stale). The calculation at line 11 can also be written as:

$$\text{?} ← \frac{1}{M} ( {Δ}_{m}^{( t )} + {\sum }_{{m}^{′} \neq m} {Δ}_{{m}^{′}}^{( t - H )} )$$

which brings out that the process computes an average of the current local outer gradient

$$( {Δ}_{m}^{( t )} )$$

and all the stale non-local outer gradients

$$( {Δ}_{{m}^{′}}^{( t - H )} )$$

from the other workers. At line 12 the corrected gradient is then applied using the outer optimizer, e.g. Nesterov momentum, to update the parameters from the earlier state

$${θ}_{m}^{( t - H )}$$

(rather than the current parameters, which might be at some intermediate state after local training). That is the algorithm discards the specific update trajectory the worker took during the last H local steps and instead applies the globally corrected vector to the starting point of that trajectory. This approach helps to maintain the stability of the training trajectory despite the communication delay.

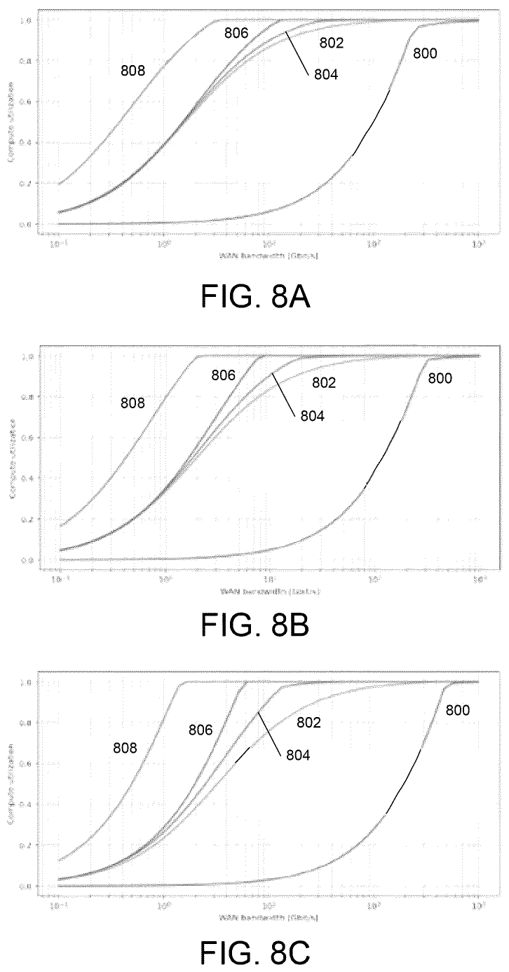

FIGS. 8A-8C illustrate the scaling performance of an example of a distributed training process according to FIG. 2. In more detail, each of the graphs show fractional compute utilization on the y-axis (1=100%), against WAN bandwidth in Gbit/s on the x-axis. FIG. 8A is for a 1B parameter model, FIG. 8B for a 10B parameter model, and FIG. 8C for a 100B parameter model; each of the models is trained on the C4 dataset (Raffel et al., arXiv:1910.10683, September 2023).

Curves 800, 802, 806 and 806 correspond to implementations of the approaches of FIGS. 5A-5D respectively (with z=1); curve 808 corresponds to an implementation of the approach of FIG. 5D in which gradients are communicated over the computer network 120 using FP4 (τ=1). For roughly the same evaluation loss and downstream task accuracy implementations of the described techniques (curves 804, 806, and 808) achieve 95% compute utilization with a bandwidth that is roughly constant between 1 Gbit/s and 5 Gbit/s, whilst the approach of FIG. 5A requires 100 Gbit/s, 200 Gbit/s and 300 Gbit/s respectively for 1B, 10B and 100B parameters.

Similar results can be obtained for implementations of a distributed training process according to FIG. 7.

In general, in implementations of the distributed training process according to FIG. 2 it has been found experimentally that three layers per fragment provides a good tradeoff between machine learning performance and reduction of peak bandwidth (for which the smaller the fragments the better). The number of inner loop optimization steps between synchronization can be varied according to the available bandwidth, e.g. it can be set at H=100 or it can be reduced, e.g. to 50 or increased, e.g. to several hundred. The communication/computation time overlap, e.g. τ above, can also be varied according to the characteristics of the worker computer systems and computer network. Merely as an example r may be in the range 1 to 50, 1 to 20, or 1 to 10, and in some implementations τ=5 has been found acceptable (with little additional gain in compute time above this).

There now follows an outline description of some language model neural networks that the techniques described herein can be used to either train from scratch or fine-tune, e.g. LLMs, or multimodal models such as VLMs. The image, video, or audio generating tasks described below can also be performed by large diffusion models, and related models such as flow matching models (trained using a diffusion model loss or related loss).

In general, a language model neural network is a neural network that has been trained so that, given a text prompt that includes a sequence of tokens in a natural language, the neural network can generate the next token in the sequence. In general, the language model neural network is trained on a corpus of text made up of tokens from a vocabulary, and optionally other tokens, to predict the next token in a sequence of tokens from the training data.

Some large language model neural networks comprise an autoregressive transformer neural network; a transformer-based language model can be an encoder-only model, a decoder-only model or an encoder-decoder model. Some large language model neural networks may comprise, e.g. a diffusion model or a mixture-of-experts model.

A language model neural network can be made to perform a particular task by providing a natural language description of the desired response as an input or “prompt”. Also or instead a language model neural network may be “fine-tuned” to perform a particular task, by obtaining a pre-trained language model neural network and then further training part of all of the language model neural network on a relatively small number of examples particular to the type of task that is to be performed.

A multimodal machine learning model, e.g. VLM, has a multimodal input configured to receive a first multimodal input and a second multimodal input (a “modality” refers to a type of data). For example the first multimodal input may comprise text and the second multimodal input may receive an image or video, i.e. data representing image pixels; or audio, i.e. data representing an audio waveform, e.g. speech. The multimodal input can be processed to generate a model output that defines a result of a machine learning task. For example, the model output may comprise text for a task such as image captioning, visual question answering, or object detection or instance segmentation; or the model output may comprise data defining an image, video, or audio e.g. speech, characterized by input text, e.g. in a generative task. As another example the model output may comprise non-textual action selection data for selecting an action to be performed by an agent controlled by the model, e.g. a mechanical agent such as a robot that performs a particular task specified by input text or audio, in an environment characterized by an input image or video. As another example, the model output can define an intermediate step to be performed during the task, e.g. a call to a software API for a software tool that is used when performing the task; the multimodal input can then receive an output from the software tool that is used to generate a final model output that performs the task.

A language model neural network, including a multimodal model, can be trained on any suitable dataset, e.g. a dataset such as WebLI (Web Language Image, Chen et al. arXiv:2305.18565v1), or any of many specialized training datasets for fine tuning, e.g. Visual Question Answering (Krishna et al.); Objects365 (Shao et al.); Open Images V4 (Kuznetsova et al.); the SBU dataset (Ordonez et al.); the Conceptual Captions datasets (Sharma et al.; Kinetics for video (Kay et al.); AudioSet for audio (Gemmeke et al.); and so on.

Any suitable training objective can be used, e.g. a self-supervised training objective. Examples include a softmax cross entropy loss (using teacher forcing); an autoregressive negative log likelihood (NLL) loss, such as

$$- {\sum }_{l = 1}^{L} log p ( {y}_{l} \vert {y}_{< l} , {x}_{\leq l} )$$

for a multimodal input comprising a sequence of text encoded as L tokens with the lth text token yₗ conditioned on preceding second modality inputs x_{≤l}, such as one or more images or videos, and conditioned on preceding text tokens y_{<l}; a masking loss that requires the model to predict masked-out data such as masked out text tokens; or a contrastive loss.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The essential elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Further aspects of the invention are defined in the following clauses:
1. A method of training a neural network using a distributed computing system comprising a plurality of worker computer systems, the neural network comprising a plurality of learnable parameters in a plurality of layers, wherein: a replica of the neural network is maintained on each worker computer system; and each worker computer system obtains training data for training the replica neural network maintained on the respective worker computer system; the method comprising a worker computer system performing: an inner optimization loop comprising training layers of the replica neural network maintained on the worker computer system for a plurality of time steps, to update the plurality of learnable parameters; and concurrently with performing the inner optimization loop, performing an outer optimization loop comprising a succession of fragment updates each updating a different fragment of the replica neural network maintained on the worker system, wherein a plurality of the fragment updates is performed during the plurality of time steps of the inner optimization loop.
2. The method of clause 1, wherein performing the inner optimization loop comprises training all the layers of the replica neural network maintained on the worker computer system for the plurality of time steps.
3. The method of clause 1 or 2, comprising continuing to perform inner optimization loop computation for updating the plurality of learnable parameters whilst waiting for communication of aggregate parameter update information for updating the fragments.
4. The method of clause 3, comprising merging results of i) performing the inner optimization loop computation whilst waiting for communication of aggregate parameter update information, and ii) a fragment update determined from the aggregate parameter update information, after receiving the aggregate parameter update information for a fragment.
5. The method of any of clauses 1-4, wherein performing a fragment update for a fragment comprises the worker computer system: determining a set of local gradients for a subset of the learnable parameters of the replica neural network corresponding to the fragment, comprising: determining a difference between current values of the subset of the learnable parameters at a current time step of the fragment update for the fragment, and preceding values of the subset of the learnable parameters at a preceding time step of a preceding fragment update for the fragment; sharing the set of local gradients by sending the set of local gradients to the other worker computer systems or to a server; receiving aggregate parameter update information from the other worker computer systems or from the server, wherein the aggregate parameter update information comprises either: i) a set of local gradients for the fragment from each of the other worker computer systems, or ii) from the server, an aggregate, for the fragment, of a set of the local gradients determined by each of the worker computer systems, or iii) from the server, a set of updated values of the subset of the learnable parameters; and updating the subset of the learnable parameters of the replica neural network corresponding to the fragment using the aggregate parameter update information.
6. The method of clause 5 when dependent on clause 4, wherein the difference results from the inner optimization loop training all the layers of the replica neural network.
7. The method of clause 5 or 6, wherein updating the subset of the learnable parameters of the replica neural network corresponding to the fragment using the aggregate parameter update information comprises: obtaining, for the fragment, an aggregate of the set of the local gradients determined by each of the worker computer systems; applying the aggregate of the set of the local gradients to the preceding values of the subset of the learnable parameters to obtain outer loop optimized values for the subset of the learnable parameters for the fragment; and updating the subset of the learnable parameters of the replica neural network corresponding to the fragment using the outer loop optimized values.
8. The method of clause 7, wherein updating the subset of the learnable parameters of the replica neural network corresponding to the fragment using the outer loop optimized values comprises: replacing the preceding values of the subset of the learnable parameters for the fragment with the outer loop optimized values.
9. The method of clause 7, comprising: continuing to perform the inner optimization loop whilst performing the outer optimization loop, to determine further updated values for the subset of the learnable parameters for the fragment from the inner optimization loop; and wherein updating the subset of the learnable parameters of the replica neural network corresponding to the fragment using the outer loop optimized values comprises: merging the outer loop optimized values and the further updated values for the subset of the learnable parameters for the fragment.
10. The method of clause 9, wherein continuing to perform the inner optimization loop whilst performing the performing an outer optimization loop comprises: continuing to perform the inner optimization loop whilst waiting to receive or receiving the aggregate parameter update information.
11. The method of clause 9 or 10, comprising: continuing to perform the inner optimization loop for an overlap number of time steps of the inner optimization loop whilst waiting to receive or receiving the aggregate parameter update information.
12. The method of any of clauses 9-11, wherein merging the outer loop optimized values and the further updated values for the subset of the learnable parameters for the fragment comprises: summing the further updated values with a weight α, and the outer loop optimized values with a weight (1−α).
13. The method of any of clauses 7-12, wherein obtaining, for the fragment, the aggregate of the set of the local gradients determined by each of the worker computer systems comprises: receiving, at the worker computer system, the set of local gradients for the fragment from each of the other worker computer systems; and aggregating the set of local gradients for the subset of the learnable parameters of the replica neural network corresponding to the fragment and the set of local gradients for the fragment received from each of the other worker computer systems.
14. The method of any of clauses 1-13, comprising performing the inner optimization loop at least once between each updating of a particular fragment of the replica neural network.
15. The method of clause 13 when dependent on clause 5, wherein the current time step is at least the plurality of time steps of the inner optimization loop after the preceding time step.
16. The method of clause 14, wherein a difference between the current time step and the preceding time step is equal to the plurality of time steps of the inner optimization loop.
17. The method of any of clauses 1-16, wherein the different fragments of the replica neural network comprise different subsets of the plurality of layers of the neural network.
18. The method of clause 17, wherein the plurality of layers of the neural network comprises a sequence of neural network layers, and wherein the different subsets of the plurality of layers comprise groups of consecutive neural network layers in the sequence.
19. The method of clause 17, wherein the plurality of layers of the neural network comprises a sequence of neural network layers, and wherein the different subsets of the plurality of layers comprise groups of interleaved neural network layers in the sequence.
20. The method of any of clauses 1-18 when dependent on clause 5, comprising: determining the set of local gradients for the subset of the learnable parameters of the replica neural network corresponding to the fragment using arithmetic of a first precision; and sending the set of local gradients to the other worker computer systems or to the server at a second, lower precision.
21. The method of clause 20, when dependent on clause 13, wherein aggregating the set of local gradients for the subset of the learnable parameters of the replica neural network corresponding to the fragment and the set of local gradients for the fragment received from each of the other worker computer systems is performed at the first precision.
22. The method of any of clauses 1-21 when dependent on clause 7, wherein the aggregate of the set of the local gradients determined by each of the worker computer systems comprises an average of the set of the local gradients determined by each of the worker computer systems.
23. The method of any of clauses 1-22, wherein the replica of the neural network on each worker computer system is initialized to have the same values for the plurality of learnable parameters.
24. The method of any of clauses 1-23, wherein each worker computer system obtains one of a plurality of shards of a training dataset for training the replica neural network.
25. The method of any of clauses 1-24, comprising: storing the learnable parameters of the replica neural network corresponding to the different fragments in first memory of the worker computer system; and when performing the fragment update for a fragment, selectively loading the subset of the learnable parameters of the replica neural network corresponding to the fragment into second memory of the worker computer system, wherein the second memory has a higher memory access bandwidth than the first memory.
26. A method of training a neural network using a distributed computing system comprising a plurality of worker computer systems, the neural network comprising a plurality of learnable parameters, wherein a replica of the neural network is maintained on each worker computer system, the method comprising a worker computer system: performing a first inner optimization loop to update the plurality of learnable parameters and determine a first set of local gradients; initiating sharing of the first set of local gradients with the other worker computer systems; performing a second inner optimization loop to further update the plurality of learnable parameters and determine a second set of local gradients, wherein performing the second inner optimization loop overlaps in time with the sharing of the first set of local gradients; receiving aggregate parameter update information derived from the first set of local gradients shared by the worker computer system and local gradients shared by the other worker computer systems; and updating the plurality of learnable parameters using a combination of the second set of local gradients and the received aggregate parameter update information.
27. The method of clause 26, wherein updating the plurality of learnable parameters comprises: calculating a corrected update by adding the received aggregate parameter update information and subtracting the first set of local gradients; and applying the corrected update to the plurality of learnable parameters.
28. The method of clause 26 or 27, wherein the second inner optimization loop is performed in its entirety without waiting for the receiving of the aggregate parameter update information to complete.
29. The method of any of clauses 26-28, wherein the plurality of learnable parameters corresponds to a fragment of the neural network, and wherein the method further comprises: performing a succession of outer optimization loops, wherein each outer optimization loop updates a different fragment of the neural network in a sequence.
30. The method of any of clauses 26-29, wherein determining the first set of local gradients is performed using a first numerical precision, and wherein initiating sharing of the first set of local gradients comprises sending the gradients at a second, lower numerical precision.
31. The method of any of clauses 26-30, comprising updating the plurality of learnable parameters using the first set of local gradients prior to performing the second inner optimization loop.
32. The method of any of clauses 26-31, wherein the duration of the second inner optimization loop is different for at least one worker computer system compared to another worker computer system in the distributed computing system.
33. The method of any of clauses 26-32, wherein updating the plurality of learnable parameters using the aggregate parameter update information comprises applying an outer optimizer to the aggregate parameter update information, and wherein a state of the outer optimizer is maintained on the worker computer system.
34. The method of any of clauses 26-33, further comprising storing the first set of local gradients or the aggregate parameter update information in a first memory (e.g., CPU RAM) and loading it into a second, higher-bandwidth memory (e.g., GPU HBM) only when performing the updating step.
35. The method of any of clauses 26-34, wherein the received aggregate parameter update information corresponds to an inner optimization loop performed at least two cycles prior to the second inner optimization loop.
36. The method of any of clauses 1-35, wherein the neural network comprises a large language model or vision language model and the plurality of learnable parameters comprises at least 109 learnable parameters.
37. One or more non-transitory computer storage media storing instructions that when executed by one or more computers cause the one or more computers to perform operations of the respective method of any one of clauses 1-36.
38. A system comprising: one or more computers; and one or more storage devices communicatively coupled to the one or more computers, wherein the one or more storage devices store instructions that, when executed by the one or more computers, cause the one or more computers to perform operations of the respective method of any one of clauses 1-36.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method of training a neural network using a distributed computing system comprising a plurality of worker computer systems, the neural network comprising a plurality of learnable parameters in a plurality of layers, wherein:
a replica of the neural network is maintained on each worker computer system; and
each worker computer system obtains training data for training the replica neural network maintained on the respective worker computer system; the method comprising a worker computer system performing:
an inner optimization loop comprising training layers of the replica neural network maintained on the worker computer system for a plurality of time steps, to update the plurality of learnable parameters; and
concurrently with performing the inner optimization loop, performing an outer optimization loop comprising a succession of fragment updates each updating a different fragment of the replica neural network maintained on the worker system, wherein a plurality of the fragment updates is performed during the plurality of time steps of the inner optimization loop.

2. The method of claim 1, wherein performing the inner optimization loop comprises training all the layers of the replica neural network maintained on the worker computer system for the plurality of time steps.

3. The method of claim 1, comprising continuing to perform inner optimization loop computation for updating the plurality of learnable parameters whilst waiting for communication of aggregate parameter update information for updating the fragments.

4. The method of claim 3, comprising merging results of i) performing the inner optimization loop computation whilst waiting for communication of aggregate parameter update information, and ii) a fragment update determined from the aggregate parameter update information, after receiving the aggregate parameter update information for a fragment.

5. The method of claim 1, wherein performing a fragment update for a fragment comprises the worker computer system:
determining a set of local gradients for a subset of the learnable parameters of the replica neural network corresponding to the fragment, comprising:
determining a difference between current values of the subset of the learnable parameters at a current time step of the fragment update for the fragment, and preceding values of the subset of the learnable parameters at a preceding time step of a preceding fragment update for the fragment;
sharing the set of local gradients by sending the set of local gradients to the other worker computer systems or to a server;
receiving aggregate parameter update information from the other worker computer systems or from the server, wherein the aggregate parameter update information comprises either: i) a set of local gradients for the fragment from each of the other worker computer systems, or ii) from the server, an aggregate, for the fragment, of a set of the local gradients determined by each of the worker computer systems, or iii) from the server, a set of updated values of the subset of the learnable parameters; and
updating the subset of the learnable parameters of the replica neural network corresponding to the fragment using the aggregate parameter update information.

6. The method of claim 5, comprising:
determining the set of local gradients for the subset of the learnable parameters of the replica neural network corresponding to the fragment using arithmetic of a first precision; and
sending the set of local gradients to the other worker computer systems or to the server at a second, lower precision.

7. The method of claim 5, wherein updating the subset of the learnable parameters of the replica neural network corresponding to the fragment using the aggregate parameter update information comprises:
obtaining, for the fragment, an aggregate of the set of the local gradients determined by each of the worker computer systems;
applying the aggregate of the set of the local gradients to the preceding values of the subset of the learnable parameters to obtain outer loop optimized values for the subset of the learnable parameters for the fragment; and
updating the subset of the learnable parameters of the replica neural network corresponding to the fragment using the outer loop optimized values.

8. The method of claim 7, wherein updating the subset of the learnable parameters of the replica neural network corresponding to the fragment using the outer loop optimized values comprises:
replacing the preceding values of the subset of the learnable parameters for the fragment with the outer loop optimized values.

9. The method of claim 7, comprising:
continuing to perform the inner optimization loop whilst performing the outer optimization loop, to determine further updated values for the subset of the learnable parameters for the fragment from the inner optimization loop; and
wherein updating the subset of the learnable parameters of the replica neural network corresponding to the fragment using the outer loop optimized values comprises:
merging the outer loop optimized values and the further updated values for the subset of the learnable parameters for the fragment.

10. The method of claim 9, wherein continuing to perform the inner optimization loop whilst performing the performing an outer optimization loop comprises:
continuing to perform the inner optimization loop whilst waiting to receive or receiving the aggregate parameter update information.

11. The method of claim 7, wherein obtaining, for the fragment, the aggregate of the set of the local gradients determined by each of the worker computer systems comprises:
receiving, at the worker computer system, the set of local gradients for the fragment from each of the other worker computer systems; and
aggregating the set of local gradients for the subset of the learnable parameters of the replica neural network corresponding to the fragment and the set of local gradients for the fragment received from each of the other worker computer systems.

12. The method of claim 1, wherein the plurality of layers of the neural network comprises a sequence of neural network layers, wherein the different fragments of the replica neural network comprise different subsets of the plurality of layers of the neural network, and wherein the different subsets of the plurality of layers comprise groups of interleaved neural network layers in the sequence.

13. The method of claim 1, comprising:
storing the learnable parameters of the replica neural network corresponding to the different fragments in first memory of the worker computer system; and
when performing the fragment update for a fragment, selectively loading the subset of the learnable parameters of the replica neural network corresponding to the fragment into second memory of the worker computer system, wherein the second memory has a higher memory access bandwidth than the first memory.

14. A method of training a neural network using a distributed computing system comprising a plurality of worker computer systems, the neural network comprising a plurality of learnable parameters, wherein a replica of the neural network is maintained on each worker computer system, the method comprising a worker computer system:
performing a first inner optimization loop to update the plurality of learnable parameters and determine a first set of local gradients;
initiating sharing of the first set of local gradients with the other worker computer systems;
performing a second inner optimization loop to further update the plurality of learnable parameters and determine a second set of local gradients, wherein performing the second inner optimization loop overlaps in time with the sharing of the first set of local gradients;
receiving aggregate parameter update information derived from the first set of local gradients shared by the worker computer system and local gradients shared by the other worker computer systems; and
updating the plurality of learnable parameters using a combination of the second set of local gradients and the received aggregate parameter update information.

15. The method of claim 14, wherein updating the plurality of learnable parameters comprises: calculating a corrected update by adding the received aggregate parameter update information and subtracting the first set of local gradients; and applying the corrected update to the plurality of learnable parameters.

16. The method of claim 14, wherein the second inner optimization loop is performed in its entirety without waiting for the receiving of the aggregate parameter update information to complete.

17. The method of claim 14, wherein the plurality of learnable parameters corresponds to a fragment of the neural network, and wherein the method further comprises: performing a succession of outer optimization loops, wherein each outer optimization loop updates a different fragment of the neural network in a sequence.

18. The method of claim 14, wherein determining the first set of local gradients is performed using a first numerical precision, and wherein initiating sharing of the first set of local gradients comprises sending the gradients at a second, lower numerical precision.

19. The method of claim 14, comprising updating the plurality of learnable parameters using the first set of local gradients prior to performing the second inner optimization loop.
